(19) United States
(12) Patent Application Publication
(10) Pub. No.: US 2006/0267318 A1
(43) Pub. Date: Nov. 30, 2006

(54) Airbag device for vehicle

(75) Inventors: Satoshi Nishikaji, Aki-gun (JP); Katsuyoshi Ishigame, Aki-gun (JP); Tsutomu Sugahara, Aki-gun (JP); Seigo Taguchi, Aki-gun (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/500,942

(22) Filed: Aug. 9, 2006

Related U.S. Application Data
(62) Division of application No. 10/765,180, filed on Jan. 28, 2004.

(30) Foreign Application Priority Data
Jan. 29, 2003 (JP) 2003-019792
Feb. 20, 2003 (JP) 2003-042368
Feb. 24, 2003 (JP) 2003-045849

(51) Int. Cl. B60R 21/207; B60R 21/26

(52) U.S. Cl. 280/730.2; 280/742

(57) ABSTRACT

An inflatable airbag, which inflates and comes out from a side portion of a seat back, comprises a head-protection portion and a torso-protection portion which are formed separately. A volume of the head-protection portion for protecting an occupant's head is configured to be greater than that of the torso-protection portion for protecting at least an occupant's chest. A tether connecting the both airbag portions can provide a proper forward inflation of the head-protection portion, suppressing an upward inflation of the head-protection portion. An arrangement of a vent hole or a coating layer can make an inflation sustaining period of the head-protection portion longer than that of the torso-protection portion in the inflated condition.

### BACKGROUND OF THE INVENTION

The present invention relates to an airbag device for a vehicle which functions in the event of a side impact of the vehicle.

Recently, many vehicles have been equipped with, so-called, a side airbag device for protecting an occupant properly in a side impact of the vehicle. This kind of airbag device comprises an inflatable airbag mounted within a seat back of a seat for the occupant and arranged to inflate forward and between the occupant and a vehicle side body in the side impact of the vehicle.

A certain type of the inflatable airbag inflated between the occupant and the vehicle side body in the side impact of the vehicle has a large volume so as to be located over the occupant's head and chest. For instance, Japanese Patent Laid-Open Publication No. 9-136600 discloses an inflated airbag extending in a vertical direction of the vehicle as a whole, having a first portion which is located below thereof and at a side of an occupant's chest and a second portion which is located above thereof and at a side of an occupant's head. The airbag is formed as one unit inflatable bag and a partition for forming the above-described first and second portions is provided inside of the airbag. The partition is configured so as to be broken in the event of the inflation of the airbag.

Further, Japanese Patent Laid-Open Publication No. 9-220993 discloses an inflatable airbag which is formed as one unit airbag as a whole but comprises an upper portion located at the side of the occupant's head and a lower portion located at the side of the occupant's chest in an inflated condition. Herein, the upper portion and the lower portion are connected with each other through a rear portion located reward of the airbag having a small cross-section area. Namely, the airbag disclosed herein has a shape with a forward-opening portion at the middle thereof.

Herein, it is needed that the inflated airbag between the occupant and the vehicle side body is located securely at the side of the Occupant's head and chest. However, it may be difficult actually that the inflated airbag is always located at its right place at the side of the occupant's head securely due to a difference in a body size of occupants. Namely, since there is a limit to a perfect design of the inflatable airbag with a large volume as a practical matter, there is a possibility that an airbag which is designed appropriately for relatively small-size occupants so as to be located at a whole side of such occupant's head would not necessarily suit to relatively large-size occupants, providing so limited protection that the airbag is located at only a lower part of the side of such occupant's head.

Further, in the event of the side impact of the vehicle, the occupant's chest firstly moves toward the vehicle side body and then the occupant's head moves toward the vehicle side body. Accordingly, it is needed to adjust an inflation completion timing of the inflatable airbag such that the inflated airbag can be firstly located at the side of the occupant's chest, and at the same time or a little later it can be located at the side of the occupant's head. Further, it is also needed to adjust an inflation sustaining period of the inflatable airbag such that an airbag portion for protecting the occupant's head can maintain its inflation for a longer period than an airbag portion protecting for the occupant's chest.

However, it is difficult to apply such arrangements to the inflatable airbag formed as one unit airbag basically, which are disclosed in the above-described patent publications, i.e., corresponding to the occupant-size difference, and adjusting appropriate inflation completion timing and inflation sustaining period for the airbag portion for the occupant's head and the airbag portion of the airbag for the occupant's chest, respectively.

### SUMMARY OF THE INVENTION

The present invention has been devised in view of the above-described problem, and an object of the present invention is to provide an airbag device for a vehicle that can protect an occupant's head appropriately.

In order to achieve the above-described object, the first aspect of the present invention provides an airbag device for a vehicle, comprising an inflatable airbag mounted within a seat back of a seat for an occupant and arranged to inflate forward and between the occupant and a vehicle side body in the event of a side impact of the vehicle, an inflator responsive to the side impact of the vehicle for generating gas to inflate the airbag, wherein the airbag comprises a head-protection portion arranged to be located at a side of a head of the occupant and a torso-protection portion arranged to be located at a side of at least a chest of the occupant in the inflated condition, and the head-protection portion and the torso-protection portion are formed separately and configured such that a volume of the head-protection portion is greater than that of the torso-protection portion at the time their inflation is completed.

According to the airbag device of the first aspect of the invention, since the inflatable airbag is configured of the head-protection portion and the torso-protection portion which are formed separately, it should be easy to adjust appropriately an inflation completion timing, an inflation sustaining period or the like for each of the head-protection portion and the torso-protection portion of the airbag. Further, since these separate portions of airbag are configured such that the volume of the head-protection portion is greater than that of the torso-protection portion at the time their inflation is completed, it can be achieved to place the head-protection portion with a greater volume at a substantially whole side of the occupant's head securely regardless of the occupant's body size. As a result, an appropriate and secure protection of the occupant can be attained.

The second aspect of the present invention provides the airbag device for a vehicle of the first aspect of the invention, wherein the airbag is arranged to inflate forward from a side portion of the seat back, and a lower part of the head-protection portion and an upper part of the torso-protection portion are connected by a tether such that a forward inflation-force of the torso-protection portion generated in the inflated condition is conveyed to the head-protection portion through the tether.

In general, the head-protection portion of airbag tends to inflate upward, due to a folded arrangement of airbag, an large space existing above the seat back and beside the vehicle side body and so on. According to the airbag device of the second aspect of the invention, however, such forward inflation-force of the torso-protection portion, which is generated strongly by nature in the inflated condition, is conveyed to the head-protection portion through the tether. Accordingly, it can be achieved that the head-protection portion of airbag is moved and located immediately forward the side of the occupant's head so as to cover a whole area of the occupant's head.

The third aspect of the present invention provides the airbag device for a vehicle of the first aspect of the invention, wherein the airbag is arranged to inflate forward from a side portion of the seat back, and a lower part of the head-protection portion and an upper part of the torso-protection portion are connected by a tether such that an upward inflation of the head-protection portion in the inflated condition is suppressed by the torso-protection portion through the tether.

The head-protection portion of airbag tends to inflate upward, as described above. However, according to the airbag device of the third aspect of the invention, the torso-protection portion located below of the airbag suppresses the upward movement of the head-protection portion through the tether. Accordingly, it can be achieved that the head-protection portion of airbag is located at the side of the occupant's head securely.

The fourth aspect of the present invention provides the airbag device for a vehicle of the first aspect of the invention, wherein the head-protection portion and the torso-protection portion are configured such that an inflation sustaining period of the head-protection portion is longer than that of the torso-protection portion in the inflated condition.

According to the airbag device of the fourth aspect of the invention, the head-protection portion of airbag can be maintained in its inflated condition even after the torso-protection portion has become deflated. Thus, appropriated protection can be achieved.

The fifth aspect of the present invention provides the airbag device for a vehicle of the fourth aspect of the invention, wherein at least one of the head-protection portion and the torso-protection portion comprises a vent hole formed thereat, and the configuration that the inflation sustaining period of the head-protection portion is longer than that of the torso-protection portion in the inflated condition is adjusted by the vent hole.

According to the airbag device of the fifth aspect of the invention, a use of the vent hole can make the inflation sustaining period of the head-protection portion longer than that of the torso-protection portion in the inflated condition.

The sixth aspect of the present invention provides the airbag device for a vehicle of the fourth aspect of the invention, wherein at least one of the head-protection portion and the torso-protection portion comprises a material coated on an inside surface thereof, and the configuration that the inflation sustaining period of the head-protection portion is longer than that of the torso-protection portion in the inflated condition is adjusted by the coated material.

According to the airbag device of the sixth aspect of the invention, a use of the coated material influencing gas permeablility of the inflatable airbag can make the inflation sustaining period of the head-protection portion longer than that of the torso-protection portion in the inflated condition.

The seventh aspect of the present invention provides the airbag device for a vehicle of the first aspect of the invention, further comprising an inflation assist device that promotes a forward movement of the inflation of the head-protection portion and suppresses an upward movement thereof at the beginning of its inflation.

According to the airbag device of the seventh aspect of the invention, the head-protection portion of airbag which tends to move upward can be directed forward. Thus, it can be achieved that the head-protection portion of airbag is located at the side of the occupant's head securely.

The eighth aspect of the present invention provides the airbag device for a vehicle of the first aspect of the invention, wherein the head-protection portion and the torso-protection portion are configured so as to complete their inflation at substantially the same time.

According to the airbag device of the eighth aspect of the invention, respective inflation completion timing of the head-protection portion and the torso-protection portion can be set at their appropriate timing.

The ninth aspect of the present invention provides the airbag device for a vehicle of the first aspect of the invention, wherein the head-protection portion and the torso-protection portion are configured such that an inflation completion timing of the torso-protection portion is earlier than that of the head-protection portion.

According to the airbag device of the ninth aspect of the invention, respective inflation completion timing of the head-protection portion and the torso-protection portion can be set at their more appropriate timing.

The tenth aspect of the present invention provides the airbag device for a vehicle of the first aspect of the invention, wherein the inflator is formed as a common one for supplying the gas to both of the head-protection portion and the torso-protection portion, and there is provided a distributor for distributing the gas generated by the common inflator to the head-protection portion and the torso-protection portion.

According to the airbag device of the tenth aspect of the invention, since the inflator, which is generally expensive, for the head-protection portion and the torso-protection portion is formed as one common inflator, a relatively low-cost airbag device can be obtained. Further, since the distributor adjusts properly a gas supply to the head-protection portion and the torso-protection portion, a desirable gas supply to the both airbag portions can be attained by even one inflator.

The eleventh aspect of the present invention provides the airbag device for a vehicle of the tenth aspect of the invention, wherein the distributor is of a pipe shape which is connected to the inflator.

According to the airbag device of the eleventh aspect of the invention, the gas generated by the inflator can be securely supplied to respective airbag portions without an unnecessarily large space for disposing the distributor.

The twelfth aspect of the present invention provides the airbag device for a vehicle of the eleventh aspect of the invention, wherein the pipe-shaped distributor is made of cloth which is integral with the inflatable airbag comprising the head-protection portion and the torso-protection portion.

According to the airbag device of the twelfth aspect of the invention, the distributor can be made of cloth simply and cheaply, and further it should be easy to make it integral with the airbag portions.

The thirteenth aspect of the present invention provides the airbag device for a vehicle of the tenth aspect of the invention, wherein the distributor adjusts an amount of gas blowing into the head-protection portion and the torso-protection portion from the inflator respectively.

According to the airbag device of the thirteenth aspect of the invention, a use of the distributor can provide proper inflation characteristics of respective airbag portions.

The fourteenth aspect of the present invention provides the airbag device for a vehicle of the thirteenth aspect of the invention, wherein the distributor comprises a first outlet opening formed in the head-protection portion and a second outlet opening formed in the torso-protection portion, and the amount of gas blowing into the head-protection portion and the torso-protection portion is adjusted by each of opening area of the first and second outlet openings.

According to the airbag device of the fourteenth aspect of the invention, a simple method of adjusting each of opening area of the first and second outlet openings can make the amount of gas blowing into respective airbag portions desirable.

The fifteenth aspect of the present invention provides the airbag device for a vehicle of the thirteenth aspect of the invention, wherein the distributor comprises a first outlet opening formed in the head-protection portion and a second outlet opening formed in the torso-protection portion, and the amount of gas blowing into the head-protection portion and the torso-protection portion is adjusted by the number of each of the first and second outlet openings formed.

According to the airbag device of the fifteenth aspect of the invention, a simple method of adjusting the number of each of the first and second outlets formed can make the amount of gas blowing into respective airbag portions desirable.

The sixteenth aspect of the present invention provides the airbag device for a vehicle of the thirteenth aspect of the invention, wherein the amount of gas blowing into the head-protection portion and the torso-protection portion is adjusted such that the amount of gas blowing into the head-protection portion is greater than that of gas blowing into the torso-protection portion.

According to the airbag device of the sixteenth aspect of the invention, the inflation of the head-protection portion of the airbag can be attained securely, resulting in a secure protection of the occupant's head.

The seventh aspect of the present invention provides the airbag device for a vehicle of the tenth aspect of the invention, wherein an adjustment of the gas distribution by the distributor is configured such that the head-protection portion and the torso-protection portion complete their inflation at substantially the same time.

According to the airbag device of the seventeenth aspect of the invention, setting respective inflation completion timing of head-protection portion and the torso-protection portion at substantially the same time can improve further a secure protection of the occupant's head.

The eighteenth aspect of the present invention provides the airbag device for a vehicle of the tenth aspect of the invention, wherein an adjustment of the gas distribution by the distributor is configured such that the head-protection portion and the torso-protection portion complete their inflation at substantially the same time, and the head-protection portion and the torso-protection portion are configured such that an inflation sustaining period of the head-protection portion is longer than that of the torso-protection portion in the inflated condition.

According to the airbag device of the eighteenth aspect of the invention, a secure protection of the occupant's head can be attained regardless of the occupant's body size.

The ninth aspect of the present invention provides the airbag device for a vehicle of the tenth aspect of the invention, wherein the head-protection portion, the torso-protection portion, the inflator and the distributor are disposed within the seat back respectively, and the head-protection portion and the torso-protection portion are arranged to inflate forward from a side portion of the seat back.

According to the airbag device of the nineteenth aspect of the invention, mounting of these respective members to provide proper one-unit disposition and compactness thereof can be attained.

The twentieth aspect of the present invention provides the airbag device for a vehicle of the nineteenth aspect of the invention, wherein the inflator is located in either one of the head-protection portion and the torso-protection portion, without being located in the other one, and the distributor connected to the inflator extends into the other one.

According to the airbag device of the twentieth aspect of the invention, the inflator can be located in either one of the airbag portions, having a secure gas supply to the other one.

The twenty-first aspect of the present invention provides the airbag device for a vehicle of the first aspect of the invention, wherein the inflator is comprised of a first inflator for supplying the gas to the head-protection portion and a second inflator for supplying the gas to the torso-protection portion, which are formed separately, and the first and second inflators have gas supply characteristics different from each other.

According to the airbag device of the twenty-first aspect of the invention, since separate inflators for the head-protection portion and the torso-protection portion are provided, respective gas supply characteristics of the airbag portions can be set properly and thereby desirable inflation completion timing can be obtained securely for the respective airbag portions.

The twenty-second aspect of the present invention provides the airbag device for a vehicle of the twenty-first aspect of the invention, wherein an amount of gas supply of the first inflator is greater than that of the second inflator.

According to the airbag device of the twenty-two aspect of the invention, proper setting of the inflation completion timing can be obtained without delaying the inflation completion timing of the head-protection portion, resulting in an appropriate protection of the occupant's head.

The twenty-third aspect of the present invention provides the airbag device for a vehicle of the twenty-first aspect of the invention, wherein an adjustment of the gas supply characteristics of the first and second inflators is configured such that the head-protection portion and the torso-protection portion complete their inflation at substantially the same time.

According to the airbag device of the twenty-third aspect of the invention, especially secure protection of the occupant's head can be obtained.

The twenty-fourth aspect of the present invention provides the airbag device for a vehicle of the twenty-first aspect of the invention, wherein an adjustment of the gas supply characteristics of the first and second inflators is configured such that an inflation completion timing of the torso-protection portion is earlier than that of the head-protection portion.

According to the airbag device of the twenty-fourth aspect of the invention, the inflation completion timing for respective airbag portions can be set at the most appropriate timing.

The twenty-fifth aspect of the present invention provides the airbag device for a vehicle of the first aspect of the invention, wherein the vehicle is a type of open car.

According to the airbag device of the twenty-fifth aspect of the invention, an appropriate airbag device can be provided with respect to the open-car type of vehicle, an upper portion of which has an open structure, and, therefore, an appropriate protection of the occupant's head is needed strongly.

The twenty-sixth aspect of the present invention provides an airbag device for a vehicle, comprising an inflatable airbag mounted within a seat back of a seat for an occupant and arranged to inflate forward and between the occupant and a vehicle side body in the event of a side impact of the vehicle, the airbag comprising a head-protection portion arranged to be located at a side of a head of the occupant and a torso-protection portion arranged to be located at a side of at least a chest of the occupant in the inflated condition, the head-protection portion and the torso-protection portion being formed separately, an inflator responsive to the side impact of the vehicle for generating gas to inflate the airbag, the inflator being formed as a common one for supplying the gas to both of the head-protection portion and the torso-protection portion, and a distributor for distributing the gas generated by the inflator for the head-protection portion and the torso-protection portion, the distributor being of a pipe shape which is connected to the inflator and made of cloth which is integral with the inflatable airbag comprising the head-protection portion and the torso-protection portion. Herein, the head-protection portion and the torso-protection portion are configured such that a volume of the head-protection portion is greater than that of the torso-protection portion at the time their inflation is completed, and an amount of gas blowing into the head-protection portion and the torso-protection portion is adjusted by the distributor such that the mount of gas blowing into the head-protection portion is greater than that of gas blowing into the torso-protection portion.

According to the airbag device of the twenty-sixth aspect of the invention, substantially the same functions and effects as the above-described airbag devices of the first, tenth through thirteenth and sixteenth aspects of the invention can be obtained.

### BRIEF DESCRIPTION OF THE DRAWINGS

Other features, aspects, and advantage of the present invention will become apparent from the following description of the present invention which refers to the accompanying drawings.

FIG. 1 is a perspective view of an essential part of a vehicle which is equipped with an airbag device according to the first embodiment of the present invention.

FIG. 2 is a side view of an essential part of a head-protection portion and a torso-protection portion of an inflated airbag, when viewed from an outside of a vehicle body.

FIG. 3 is an elevation view of respective portions of the inflated airbag shown in FIG. 2, when viewed from a front side of the vehicle.

FIG. 4 is a block diagram for showing an exemplified control system.

FIG. 5 is a side view for showing an exemplified airbag having a vent hole and a coated layer.

FIG. 6 is a sectional view taken on line X6-X6 of FIG. 5.

FIG. 7 is a schematic side view of an essential part of an airbag device according to the second embodiment of the present invention.

FIG. 8 is a schematic side view of an essential part of an airbag device according to the third embodiment of the present invention.

FIG. 9 is a schematic side view of an essential part of an airbag device according to the fourth embodiment of the present invention.

FIG. 10 is a schematic side view of an essential part of an airbag device according to the fifth embodiment of the present invention.

FIG. 11 is a side view of an essential part of a head-protection portion and a torso-protection portion of an inflated airbag according to the sixth embodiment of the present invention, when viewed from an outside of a vehicle body.

FIG. 12 is a block diagram for showing an exemplified control system according to the sixth embodiment of the present invention.

### DETAILED DESCRIPTION OF THE INVENTION

### Embodiment 1

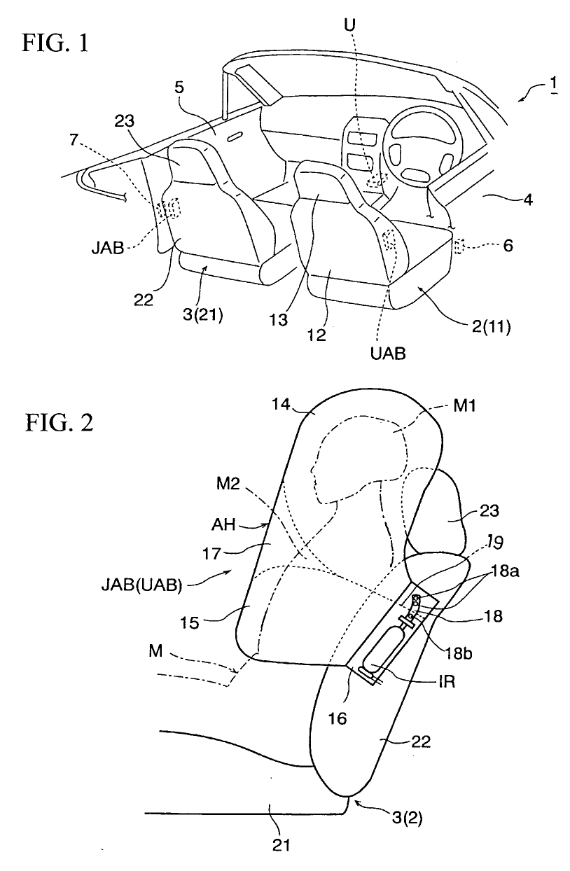

In FIG. 1, a reference numeral 1 denotes an open-car type of a vehicle, and a driver seat and a passenger seat are denoted by reference numerals 2 and 3, respectively. A side door, which constitutes part of a vehicle side body, disposed at the driver seat's side is denoted by a reference numeral 4, while a side door disposed at the passenger seat's side is denoted by a reference numeral 5. The driver seat 2, as well known, comprises a set cushion 11, a seat back 12 and a headrest 13. Likewise, the passenger seat 3 comprises a set cushion 21, a seat back 22 and a headrest 23.

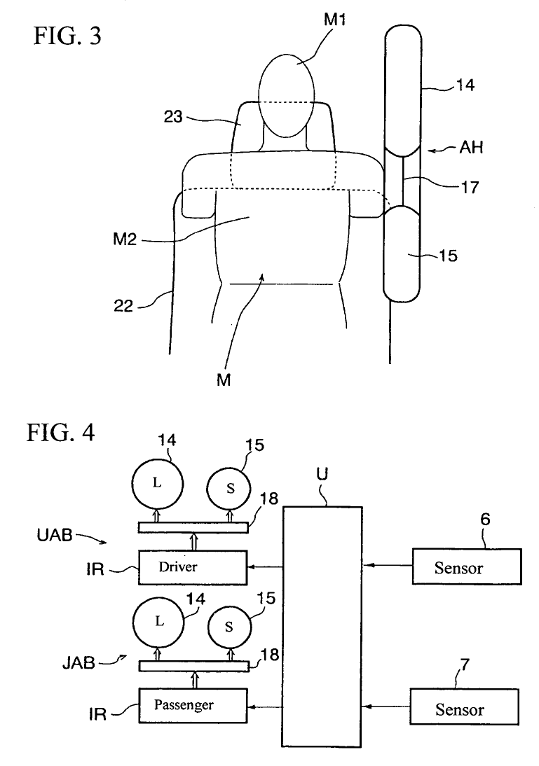

An airbag device (side airbag device) UAB is mounted within the seat back 12 of the driver seat 2, while an airbag device (side airbag device) JAB is mounted within the seat back 22 of the passenger seat 3. Both of the airbag devices UAB and JAB have substantially the same structure, thus hereinafter only the airbag device for passenger seat JAB will be described in detail referring to FIGS. 2 and 3.

The airbag device JAB includes an inflatable airbag AH and an inflator IR for generating gas pressure. The inflatable airbag AH comprises a head-protection portion 14 and a torso-protection portion 15, which are formed separately. The head-protection portion 14 is arranged so as to be located at a side of a head M1 of an occupant (passenger) M sitting on the passenger seat 3 and to have a large enough volume to cover the occupant's head M1 wholly from the outside of the vehicle in its inflated condition. Namely, the head-protection portion 14 is arranged such that it inflates at an upper portion of a space formed between the occupant (passenger) and the side door 5 at the passenger seat's side and its upper end extends beyond the set back 22 and the headrest 23. A front end of the inflated head-protection portion 14 extends forward beyond the occupant's head M1.

Meanwhile, the torso-protection portion 15 is arranged so as to be located at a side of at least a chest M2 of the occupant (passenger) M sitting on the passenger seat 3 and to have a large enough volume to cover the occupant's chest M2 wholly from the outside of the vehicle in its inflated condition. Namely, the torso-protection portion 15 is arranged such that it inflates at a lower portion of a space formed between the occupant (passenger) and the side door 5 at the passenger seat's side, more specifically at a middle position of the seat back 22 in a vertical direction of the vehicle. Herein, the torso-protection portion 15 may be configured so as to extend toward a lumber portion of the occupant M to protect the occupant's lumbar portion as well. The head-protection portion 14 and the torso-protection portion 15 are configured such that a volume (maximum volume) of the head-protection portion 14 is greater than that of the torso-protection portion 15 at the time their inflation is completed. For instance, the maximum volume of the head-protection portion 14 is configured so as to be about 40 to 100% larger than that of the torso-protection portion 15. (In FIG. 4, a letter “L” means “Large” volume, and a letter “S” means “Small” volume of the respective airbag portions 14, 15.)

The airbag portions 14, 15 are folded up respectively and then mounted within the seat back 22. When the inflator IR is activated, the airbag portions 14, 15 receive gas pressure generated by the inflator IR, and beak a weak portion 16 formed at a side surface of the seat back 22, and then inflate outward from the seat back 22.

In FIGS. 1 and 4, a side impact of the vehicle is detected by sensors 6 and 7 which are disposed in either of the side door 4, 5. A controller U including a micro computer receives outputs of the sensors 6, 7 and activates the inflator IR, as described above, based on the outputs of the sensors.

The torso-protection portion of airbag 15 inflates forward. The head-protection portion of airbag 14 also inflates forward, but it tends to inflate upward. Namely, the inflatable head-protection portion 14 is folded up in the vertical direction of the seat so as to inflates upward beyond the seat back 22, and accordingly it tends to inflate upward. Further, the weak portion 16, which is formed at a side surface of the seat back 22 and through which the airbag portions 14, 15 come out, is located at a lower position than the inflated head-protection portion 14, and there exists a relatively large space formed above the weak portion 16. Accordingly, the head-protection portion of airbag 14 intends to inflate upward for this reason as well.

Further, there is provided a tether 17 to make the head-protection portion of airbag 14 inflate forward to the utmost, suppressing its upward inflation. The tether 17, for example, is of a sheet shape, and it connects an lower portion (especially, a front-lower portion) of the head-protection portion of airbag 14 with an upper portion (especially, a front-upper portion) of the torso-protection portion 15. The tether 17 can convey a forward inflation-force of the torso-protection portion of airbag 15, which tends to inflate forward by nature, to the head-protection portion 14. Thereby, the head-protection portion 14 comes to have a tendency to inflate forward. As a result, the head-protection portion of airbag 14 can inflate so as to extend forward of the occupant's head M1 as quickly as possible.

Further, the tether 17 can also avoid a situation where the head-protection portion 14 extends upward unnecessarily. Namely, a movement of the head-protection portion 14 which would extend upward unnecessarily is effectively suppressed by the torso-protection portion 15 through the tether 17.

The head-protection portion 14 and the torso-protection portion 15 are inflated by one common inflator IR. Namely, the inflator IR itself is disposed (mounted) in either one of airbag portions (torso-protection portion of airbag 15, in the present embodiment), not in the other airbag portion. As shown in FIG. 2, a distributing pipe 18 as a distributor, through which the generated gas is supplied, is connected to the inflator IR at one end thereof. The other end of the distributing pipe 18 extends in the head-protection portion 14 and the torso-protection portion 15 respectively. More specifically, the distributing pipe 18 penetrates a partition wall 19 with a gastightness, which corresponds to an upper wall of the torso-protection portion 15 and a lower wall of the head-protection portion 14 respectively in their inflated condition, and an end portion thereof extends into the head-protection portion 14. Herein, the upper wall of the torso-protection portion 15 and the lower wall of the head-protection portion 14 may be formed separately, or either one of their walls may be also used for the other.

The above-described distributing pipe 18 is provided with an outlet openings for gas pressure (first outlet opening) 18a which are open in the head-protection portion 14 and an another outlet opening for gas pressure (second outlet opening) 18b which is open in the torso-protection portion 15. The total opening area of the outlet openings 18a for the head-protection portion 14 is configured so as to be much greater than that of the outlet opening 18b for the torso-protection portion 15. In the present embodiment, there is provided a difference in the total opening area with a larger number of the outlet openings 18a than the outlet opening 18b having the same opening area of each of respective outlet openings. This structure can give priority to a gas-pressure supply to the head-protection portion 14. Accordingly, a necessary time to complete the inflation of the head-protection portion 14 having with a larger volume becomes almost the same as a necessary time to complete the inflation of the torso-protection portion 15 having with a smaller volume. Herein, the distributing pipe 18 may be made of metal or resin (especially, rigid resin).

Herein, it is preferable that an inflation sustaining period of the head-protection portion 14 is longer than that of the torso-protection portion 15. Namely, it is preferable that the head-protection portion 14 keep its inflated state even after the torso-protection portion 15 has deflated. Accordingly, a gas relief of inflated airbag portions 14, 15 is adjusted appropriately.

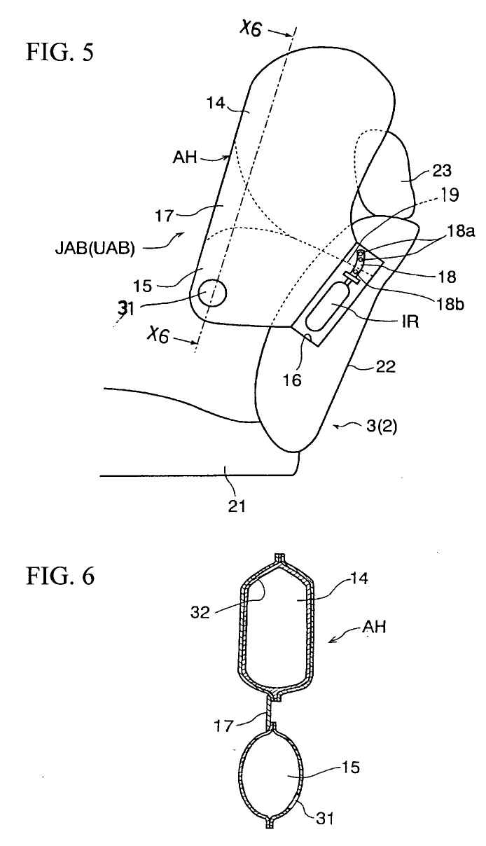

With respect to such gas-pressure relief of respective airbag portions 14, 15, an exemplified method shown in FIGS. 5 and 6 can be also applied. Namely, a vent hole 31 is formed at the torso-protection portion 15, while no vent hole is formed at the head-protection portion 14. Also, the head-protection portion 14 comprises a material coated on an inside surface thereof (coating layer is denoted by a reference numeral 32), which can make a gas-pressure relief (leak) per unit area of the head-protection portion 14 smaller. Meanwhile, the torso-protection portion 15 comprises no material coated on an inside surface thereof. The vent hole 31 and the coating layer 32 make the gas-pressure relief from the head-protection portion 14 delayed compared with the torso-protection portion 15, so that the inflation sustaining period of the head-protection portion 14 can be maintained long enough. Herein, in FIG. 6, each thickness of airbag material of the airbag portions 14, 15 and the coating layer 32 is illustrated on an enlarged scale in order to manifest their existence.

A proper combination of the vent hole 31 and the coating layer 32 can also make the inflation sustaining period of the head-protection portion 14 longer than that of the torso-protection portion 15. For example, the coating layer 32 is provided only at the head-protection portion 14, while no vent hole is provided at either of the airbag portions 14, 15. Or, the vent hole 31 is provided only at the torso-protection portion 15, while no coating layer 32 is provided at the both airbag portions 14, 15. Further, there may be other possible combinations, such as that the vent holes 31 are provided at the both airbag portions 14, 15 and the opening area of them are different from each other, the coating layers 32 are provided at the both airbag portions 14, 15 and the thickness of them are different from each other.

### Embodiment 2

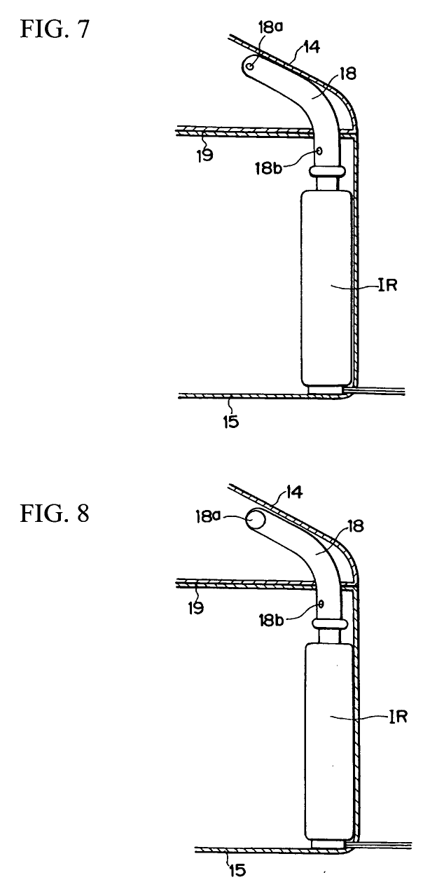

FIG. 7 shows an airbag device according to the second embodiment of the present invention. The same structure elements as the first embodiment are denoted by the same reference numerals, and duplicated description about them will be omitted hereinafter (other embodiments described hereinafter will be dealt in the same way). In the embodiment shown in FIG. 7 which corresponds to FIG. 5, the followings are the same as the first embodiment: the inflator IR is disposed only in the torso-protection portion 15; one end of the distributing pipe 18 is connected to the inflator IR and the other end hereof penetrates the partition wall and extends in the head-protection portion 14; and the distributing pipe 18 is provided with the first outlet opening 18a open in the head-protection portion 14 and the second outlet opening 18b open in the torso-protection portion 15.

In the embodiment of FIG. 7, both of the first and second outlet openings 18a, 18b have the same area and the same number of outlet opening (i.e., one each, in the present embodiment). In other word, the total opening area of the first outlet opening 18a is the same as that of the second outlet opening 18b. Accordingly, in the event that the volume of the head-protection portion 14 is configured to be larger than that of the torso-protection portion 15 at the time their inflation are completed, like the first embodiment, the inflation completion timing of the head-protection portion 14 is a little delayed, compared to the torso-protection portion 15.

### Embodiment 3

FIG. 8 shows an airbag device according to the third embodiment of the present invention, which corresponds to FIG. 7. In the present embodiment of FIG. 8, the number of the first outlet opening 18a is the same as that of the second outlet opening 18b (i.e., one each, in the present embodiment). However, the opening area of the first outlet opening 18a is larger than that of the second outlet opening 18b. Accordingly, even if the volume of the head-protection portion 14 is configured to be larger than that of the torso-protection portion 15 at the time their inflation is completed, like the embodiment of FIG. 5, the inflation completion timing of the head-protection portion 14 becomes almost the same as that of the torso-protection portion 15.

### Embodiment 4

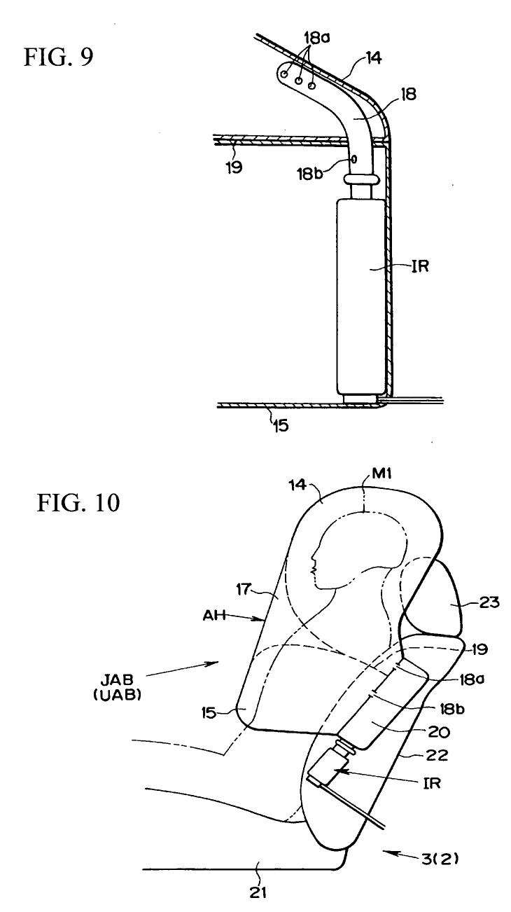

FIG. 9 shows an airbag device according to the fourth embodiment of the present invention, which corresponds to FIG. 7. In the present embodiment, although the opening area of each of the first outlet openings 18a is the same as that of the second outlet opening 18b, the number of the first outlet openings 18a is larger than that of the second outlet opening 18b. Accordingly, even if the volume of the head-protection portion 14 is configured to be larger than that of the torso-protection portion 15 at the time their inflation is completed, like the embodiment of FIG. 5, the inflation completion timing of the head-protection portion 14 becomes almost the same as that of the torso-protection portion 15.

As described above, inflation characteristics, especially the inflation completion timing of the of the head-protection portion 14 and the torso-protection portion 15 can be made desirable by adjusting the total opening area of each of the first and second outlet openings 18a, 18b. Of course, the adjustment of the total opening area of these outlet openings 18a, 18b should be done based on gas supply characteristics (especially gas volume) of the inflator IR, respective airbag volumes of the head-protection portion 14 and the torso-protection portion 15 and the like.

### Embodiment 5

FIG. 10 shows an airbag device according to the fifth embodiment of the present invention. A distributor 20 which is made of cloth is used as a distributor in the present embodiment, instead of the distributing pipe 18. The distributor 20 is integrally formed with the airbag portions 14, 15 and it becomes a substantially cylindrical shape having its longer length in the vertical direction when it is inflated. Namely, an upper end of the distributor 20 is integral with a rear end of the head-protection portion 14, and a first outlet opening 18a which is open in the head-protection portion 14 is formed at the upper end of the distributor 20. Meanwhile, a lower end of the distributor 20 is integral with a rear end of the torso-protection portion 15, and a second outlet opening 18b which is open in the torso-protection portion 15 is formed at the lower end of the distributor 20.

An inflator IR is disposed below the distributor 20, and an upper end of the inflator IR is coupled to the lower end of the distributor 20. In the present embodiment, opening area and the number of each of the outlet openings 18a, 18b are configured to be the same as each other, resulting in the same total opening area of the outlet openings 18a, 18b. As described above, however, the outlet openings 18a, 18b may be configured to have their different opening area and/or number respectively, resulting in different total opening area of the outlet openings 18a, 18b. Further, the inflator IR may be disposed at any other places than that shown in FIG. 10, such as behind or within the distributor 20, in one of the airbag portions, and the like.

Since the distributor 20 is made of cloth, the present embodiment shown in FIG. 10 is of advantage to cost and/or weight reduction or the like. Further, it can be folded within the seat back in un-inflated condition, therefore it has also the advantage of a compact mounting.

### Embodiment 6

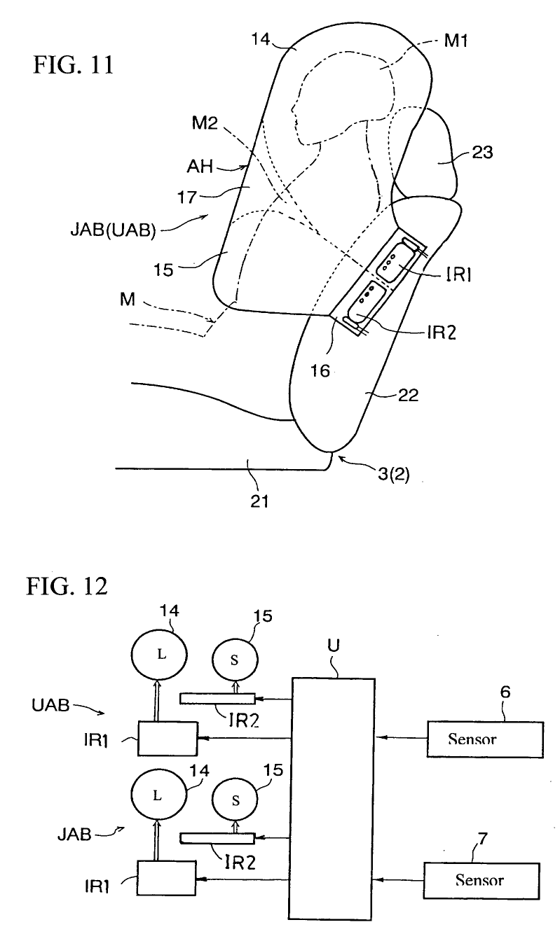

FIGS. 11, 12 show an airbag device according to the sixth embodiment of the present invention, in which an inflator is comprised of a first inflator for supplying gas to the head-protection portion of airbag and a second inflator for supplying gas to the torso-protection portion of airbag.

Namely, there are provided a first inflator IR1 and a second inflator IR2, which generate inflating gas (gas pressure) and are formed separately. The first inflator IR1 is provided for the head-protection portion of airbag 14 and inflates the airbag portion 14 by its being activated. The second inflator IR2 is provided for the torso-protection portion of airbag 15 and inflates the airbag portion 15 by its being activated. Herein, the both airbag portions 14, 15 inflate and expand out of the seat back 22, braking a weak portion 16 formed on a side face of the seat back 22 which is located at a side of the side door 5. Herein, as shown in FIG. 12, these inflators IR1, IR2 are also activated by impact sensors 6, 7 and a controller U, like the first embodiment (FIG. 4).

The two inflators IR1, IR2 are formed so as to have gas supply characteristics, especially an amount of gas supply, which is different from each other. In the present embodiment, an amount of gas supply of the first inflator IR1 is greater than that of the second inflator IR2. Namely, the volume of the head-protection portion 14 is configured to be larger than that of the torso-protection portion 15 at the time their inflation is completed. Thus, the inflation completion timing of the head-protection portion 14 is a little delayed compared to the torso-protection portion 15 because of based on the above-described arrangement of gas supply amount by the two inflators IR1, IR2. In this case, an arrangement of the same amount of gas supply by the two inflators IR1, IR2 might cause an unnecessarily delayed (too-much delayed) inflation completion timing of the head-protection portion 14 compared to the torso-protection portion 15.

Premising that the volume of the head-protection portion 14 is configured to be larger than that of the torso-protection portion 15 at the time their inflation is completed, gas supply characteristics, especially an amount of gas supply, of the respective inflators IR1, IR2 may be configured as follows. Namely, each gas supply characteristics, especially the amount of gas supply, of the inflators IR1, IR2 is set differently so that the inflation completion timing of the head-protection portion 14 can be almost the same as that of the torso-protection portion 15. (In this case, in the event that the gas supply amount of the second inflator IR2 is set at the same as that of the present embodiment, the gas supply amount of the first inflator IR1 should be set at a larger one than that of the present embodiment. This is the same situation in setting them so that the inflation completion timing of the head-protection portion 14 can be earlier than that of the torso-protection portion 15.)

The present invention is not limited to the present embodiments. The vehicle to which the present invention is applied is not limited to the above-described open-car type of vehicle. The present invention can be applied to any other types of vehicle. Further, the seat to which the present invention can be applied is not only a front seat but a rear seat. An outlet through which the airbag comes out may be formed at a front face of side portion of the seat back instead of the side face of the seat back at outside of the vehicle. Additionally, respective outlets for the head-protection portion 14 and the torso-protection portion 15 may be formed separately.

Respective rear end portions of the head-protection portion 14 and the torso-protection portion 15 may be connected integrally with each other, for example, at the portion of the partition wall 19, or formed separately. The inflation completion timing of the head-protection portion of airbag 14 may be configured so as to be a little earlier than that of the torso-protection portion of airbag 15.

Further, the above-described gas inflation characteristics of the inflators IR1, IR2 includes gas inflation pressure and the like other than the above-described gas inflation amount. Accordingly, at least one of these may be set differently between the head-protection portion of airbag 14 and the torso-protection portion of airbag 15.

Of course, the object of the present invention should include to provide any other preferable devices or embodiments which are described explicitly or implicitly herein.

What is claimed is:

1. An airbag device for a vehicle, comprising:
an inflatable airbag mounted within a seat back of a seat for an occupant and arranged to inflate forward and between the occupant and a vehicle side body in the event of a side impact of the vehicle;
an inflator responsive to the side impact of the vehicle for generating gas to inflate said airbag,
wherein said airbag comprises a head-protection portion arranged to be located at a side of a head of the occupant and a torso-protection portion arranged to be located at a side of at least a chest of the occupant in the inflated condition, and said head-protection portion and said torso-protection portion are configured such that a volume of said head-protection portion is greater than that of said torso-protection portion at the time their inflation is completed, and such that an inflation sustaining period of said head-protection portion is longer than that of said torso-protection portion in the inflated condition.

2. The airbag device for a vehicle of claim 1, wherein at least one of said head-protection portion and said torso-protection portion comprises a vent hole formed thereat, and said configuration that the inflation sustaining period of said head-protection portion is longer than that of said torso-protection portion in the inflated condition is adjusted by the vent hole.

3. The airbag device for a vehicle of claim 1, wherein a vent hole formed at the torso-protection portion is configured such that the inflation sustaining period of said head-protection portion is longer than that of said torso-protection portion.

4. The airbag device for a vehicle of claim 3, wherein said vent hole formed at the torso-protection portion is located at a side that is opposite to an occupant sitting side and at a portion that is near a front end portion of the inflated torso-protection portion.

5. The airbag device for a vehicle of claim 1, wherein at least one of said head-protection portion and said torso-protection portion comprises a material coated on an inside surface thereof, and said configuration that the inflation sustaining period of the head-protection portion is longer than that of the torso-protection portion in the inflated condition is adjusted by the coated material.

6. The airbag device for a vehicle of claim 2, wherein at least one of said head-protection portion and said torso-protection portion further comprises a material coated on an inside surface thereof, and said configuration that the inflation sustaining period of the head-protection portion is longer than that of the torso-protection portion in the inflated condition is adjusted by combination of said vent hole and the coated material.

7. The airbag device for a vehicle of claim 1, wherein said airbag is arranged to inflate forward from a side portion of the seat back, and a lower part of said head-protection portion and an upper part of said torso-protection portion are connected by a tether such that a forward inflation-force of said torso-protection portion generated in the inflated condition is conveyed to said head-protection portion through the tether.

8. The airbag device for a vehicle of claim 1, wherein said airbag is arranged to inflate forward from a side portion of the seat back, and a lower part of said head-protection portion and an upper part of said torso-protection portion are connected by a tether such that an upward inflation of said head-protection portion in the inflated condition is suppressed by said torso-protection portion through the tether.

9. The airbag device for a vehicle of claim 1, further comprising an inflation assist device that promotes a forward movement of the inflation of said head-protection portion and suppresses an upward movement thereof at the beginning of its inflation.

10. The airbag device for a vehicle of claim 1, wherein said head-protection portion and said torso-protection portion are configured so as to complete their inflation at substantially the same time.

11. The airbag device for a vehicle of claim 1, wherein said head-protection portion and said torso-protection portion are configured such that an inflation completion timing of said torso-protection portion is earlier than that of said head-protection portion.

12. The airbag device for a vehicle of claim 1, wherein said inflator is formed as a common one for supplying the gas to both of said head-protection portion and said torso-protection portion, and there is provided a distributor for distributing the gas generated by said common inflator to said head-protection portion and said torso-protection portion.

13. The airbag device for a vehicle of claim 12, wherein said distributor is of a pipe shape which is connected to said inflator.

14. The airbag device for a vehicle of claim 13, wherein said pipe-shaped distributor is made of cloth which is integral with said inflatable airbag comprising said head-protection portion and said torso-protection portion.

15. The airbag device for a vehicle of claim 12, wherein said distributor adjusts an amount of gas blowing into said head-protection portion and said torso-protection portion from said inflator respectively.

16. The airbag device for a vehicle of claim 15, wherein said distributor comprises a first outlet opening formed in said head-protection portion and a second outlet opening formed in said torso-protection portion, and said amount of gas blowing into said head-protection portion and said torso-protection portion is adjusted by each of opening area of said first and second outlet openings.

17. The airbag device for a vehicle of claim 15, wherein said distributor comprises a first outlet opening formed in said head-protection portion and a second outlet opening formed in said torso-protection portion, and said amount of gas blowing into said head-protection portion and said torso-protection portion is adjusted by the number of each of said first and second outlet openings formed.

18. The airbag device for a vehicle of claim 15, wherein said amount of gas blowing into said head-protection portion and said torso-protection portion is adjusted such that the amount of gas blowing into said head-protection portion is greater than that of gas blowing into said torso-protection portion.

19. The airbag device for a vehicle of claim 12, wherein an adjustment of the gas distribution by said distributor is configured such that said head-protection portion and said torso-protection portion complete their inflation at substantially the same time.

20. The airbag device for a vehicle of claim 12, wherein an adjustment of the gas distribution by said distributor is configured such that said head-protection portion and said torso-protection portion complete their inflation at substantially the same time, and said head-protection portion and said torso-protection portion are configured such that an inflation sustaining period of said head-protection portion is longer than that of said torso-protection portion in the inflated condition.

21. The airbag device for a vehicle of claim 12, wherein said head-protection portion, said torso-protection portion, said inflator and said distributor are disposed within the seat back respectively, and said head-protection portion and said torso-protection portion are arranged to inflate forward from a side portion of the seat back.

22. The airbag device for a vehicle of claim 21, wherein said inflator is located in either one of said head-protection portion and said torso-protection portion, without being located in the other one, and said distributor connected to said inflator extends into the other one.

23. The airbag device for a vehicle of claim 1, wherein said inflator is comprised of a first inflator for supplying the gas to said head-protection portion and a second inflator for supplying the gas to said torso-protection portion, which are formed separately, and said first and second inflators have gas supply characteristics different from each other.

24. The airbag device for a vehicle of claim 23, wherein an amount of gas supply of said first inflator is greater than that of said second inflator.

25. The airbag device for a vehicle of claim 23, wherein an adjustment of the gas supply characteristics of said first and second inflators is configured such that said head-protection portion and said torso-protection portion complete their inflation at substantially the same time.

26. The airbag device for a vehicle of claim 23, wherein an adjustment of the gas supply characteristics of said first and second inflators is configured such that an inflation completion timing of said torso-protection portion is earlier than that of said head-protection portion.

27. The airbag device for a vehicle of claim 1, wherein the vehicle is an open car.
